(19) United States
(12) Patent Application Publication
(10) Pub. No.: US 2014/0193024 A1
(43) Pub. Date: Jul. 10, 2014

(54) COMBINED SPEAKER AND AUDIO JACK

(71) Applicant: APPLE INC., Cupertino, CA (US)

(72) Inventor: John Raff, Menlo Park, CA (US)

(73) Assignee: Apple Inc., Cupertino, CA (US)

(21) Appl. No.: 13/738,822

(22) Filed: Jan. 10, 2013

(51) Int. Cl. H04R 1/02

(52) U.S. Cl. CPC H04R 1/02
USPC 381/394

(57) ABSTRACT

A speaker and audio jack module for a portable electronic device. The module includes an audio jack housing having a tube dimensioned to receive an audio plug. An acoustic port is formed through a side of the tube so as to acoustically connect a speaker housing having a speaker contained therein to the audio jack housing. The audio jack housing is capable of receiving an audio input when the audio plug is inserted therein and outputting an audio output from the speaker when the audio plug is removed.

### FIELD

An embodiment of the invention is directed to an audio jack capable of outputting sound from a speaker. Other embodiments are also described and claimed.

### BACKGROUND

Portable handheld electronic devices, such as the iPhone® multifunction device by Apple Inc., typically weigh less than a pound and fit in a pocket. These handhelds generally provide some combination of personal information management, database functions, word processing, and spreadsheets as well as voice memo recording and telephony functions. Because of the small size and portability of handhelds, strict adherence to hardware constraints, such as input hardware, must be maintained. It is conventional to have buttons or switches on the handheld computer for providing user input to the handheld computer. Handheld computers may also include one or more audio jacks that provide for connecting auxiliary devices to the handheld device (e.g., headphones). The “jack” or opening for the audio jack is typically formed through a portion of the handheld housing.

In addition to an audio jack opening, handheld devices may also include separate speaker and microphone ports formed through the housing to accommodate sound output and sound input, respectively. A separate docking port may also be formed through the housing. Each of these separate openings uses up the limited housing real estate on the handheld device. In addition to using housing real estate, sound input/output apertures and electrical connectors introduce openings in the housing and breach the barrier that protects components inside the housing.

### SUMMARY

An embodiment of the invention is directed to an audio jack for receiving an audio plug which is acoustically coupled to a driver housing having a driver contained therein such that the audio jack can both receive an audio plug for a audio jack functionality and provide a pathway for sound to travel to/from the driver. In some cases, the driver is a speaker contained within the driver housing. The driver housing is acoustically coupled to an opening formed in a side of a tube (e.g., an electrical socket) of the audio jack with an acoustic duct. In this aspect, sound output by the speaker travels from the driver housing, through the acoustic duct and out an acoustic opening at the end of the tube of the audio jack for output to a user. Since the audio jack can be used for input of an audio plug as well as output of a sound from a speaker, the number of ports or openings formed through an outer case of the associated portable electronic device can be reduced.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one.

FIG. 1 is a top schematic view of a portion of a portable electronic device having a combined audio jack and speaker module incorporated therein.

FIG. 2 is a perspective view of the combined audio jack and speaker module of FIG. 1.

FIG. 3 is a side cross sectional view along line A-A′ of the combined audio jack and speaker module of FIG. 2.

FIG. 4 is a circuit diagram of an embodiment the invention.

FIG. 5 is a flow diagram of an embodiment of a method of manufacturing a combined audio jack and speaker module.

FIG. 6 is a perspective view of one embodiment of a portable electronic device within which a combined audio jack and speaker module may be implemented.

FIG. 7 is a block diagram of a system in which embodiments of a combined audio jack and speaker may be implemented.

### DETAILED DESCRIPTION

In this section we shall explain several preferred embodiments of this invention with reference to the appended drawings. Whenever the shapes, relative positions and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known structures and techniques have not been shown in detail so as not to obscure the understanding of this description.

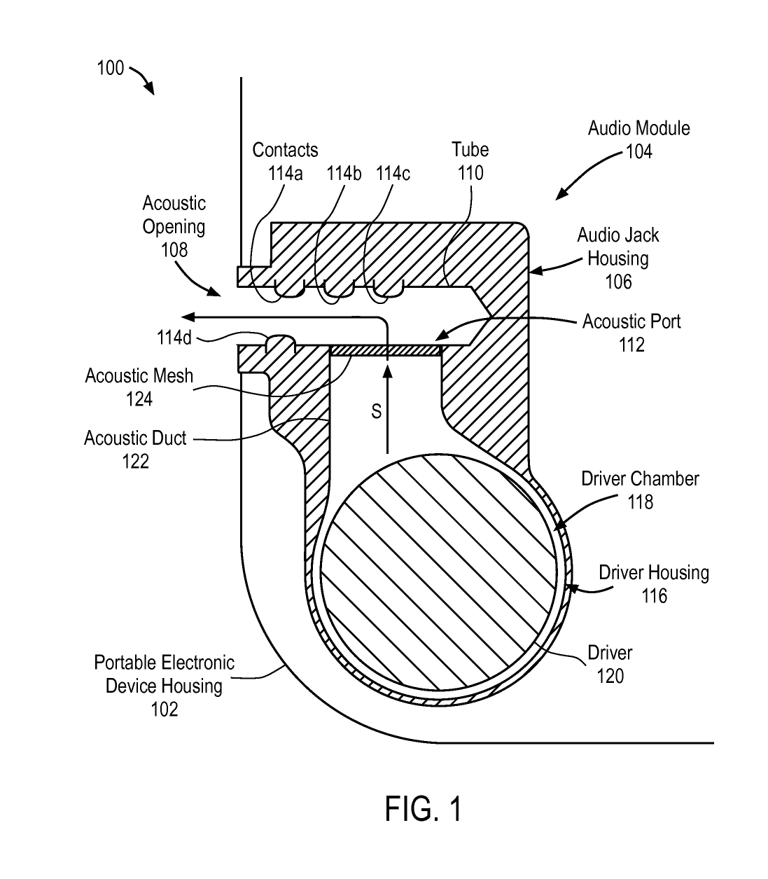

FIG. 1 is a top schematic view of a portion of a portable electronic device having a combined audio jack and speaker module incorporated therein. Representatively, electronic device 100 includes a device housing 102 which can be formed in two or more parts. FIG. 1 shows a portion of a lower part of the device housing 102. An upper part of the housing, which would be used to form the enclosed electronic device, is omitted to allow the invention to be seen more clearly.

Audio module 104 is shown mounted within device housing 102. Audio module 104 may include an audio jack housing 106 and a driver housing 116. Audio jack housing 106 may form a cavity or tube 110 having an open end aligned with an acoustic opening 108 of device housing 102. Tube 110 may be dimensioned to receive an audio plug of an audio accessory device (e.g., a headphone). For example, tube 110 may be an electrical socket dimensioned to receive an audio plug such as a 3.5 mm TRRS connector that is associated with a headset. A plurality of electrical contacts 114a, 114b, 114c and 114d may be formed along tube 110 to provide electrical connections with the audio plug when it is received in tube 110. At least one of the electrical contacts 114a, 114b, 114c and 114d may be dimensioned to mechanically engage and retain the audio plug when it is inserted into tube 110. While four electrical contacts are shown, it will be appreciated that audio jack housing 106 may have any number of electrical contacts (e.g. more than four, such as five, or less than four).

Audio jack housing 106 may be acoustically coupled to driver housing 116. Representatively, in one embodiment, acoustic port 112 may be formed through a side of tube 110. An acoustic duct 122 may extend from acoustic port 112 to driver housing 116. In this aspect, when a driver 120 is positioned within driver chamber 118 formed within driver housing 116, sound S output by driver 120, in the case of a speaker, can travel through acoustic duct 122, to tube 110 and out acoustic opening 108 to the user.

Acoustic port 112 and acoustic duct 122 may have any size and dimensions suitable for transmission of sound S between audio jack housing 106 and driver housing 116. In addition, in some embodiments, acoustic duct 122 may be dimensioned to space driver housing 116 a distance from tube 110 such that driver 120 is indirectly, as opposed to directly, coupled to tube 110. In this aspect, driver 120 is offset with respect to audio jack housing 106, and more specifically, tube 110. In still further embodiments, acoustic port 122 and/or acoustic duct 122 may be dimensioned to enhance or improve sound output via audio module 104.

An acoustic mesh 124 may further be provided within audio module 104 to enhance or improve a sound output of audio module 104. Representatively, in one embodiment, acoustic mesh 124 may be an acoustic mesh material disposed over acoustic port 112. Acoustic mesh 124 may be a piece of acoustically engineered material that provides a defined and intentional acoustic resistance or filtering effect. For example, in one embodiment, acoustic mesh 124 is a mesh or foam material that is manufactured to filter certain sound pressure waves output from driver 120. In some embodiments, acoustic mesh 124 may also help to protect the device by preventing dust, water or any other undesirable materials or articles from reaching driver 120.

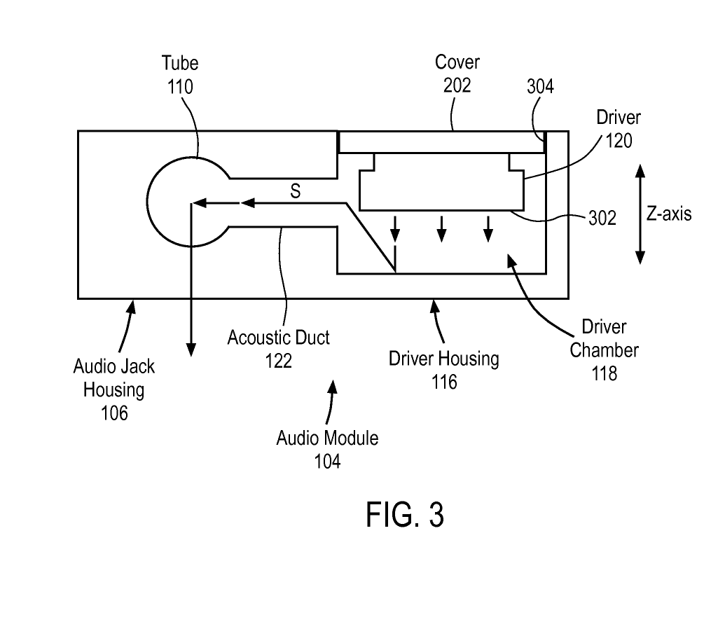

Referring now in more detail to driver housing 116 and driver 120, driver chamber 118 may be dimensioned to position driver 120 such that it does not face tube 110. For example, driver 120 may be positioned such that a face from which sound is output by driver 120 faces toward or away from a back face of device housing 102 and outputs sound S in a direction parallel to a z-axis (see FIG. 3). In this aspect, driver 120 does not substantially increase a z-height of audio module 104, and in turn, device housing 102. In addition, due to the orientation of driver 120, sound S is not directly input to tube 110, but rather is redirected from driver 120 by acoustic duct 122 and tube 110 toward acoustic opening 108. In one embodiment, driver 120 is an electroacoustic transducer that produces sound in response to an electrical audio signal input. It is contemplated, however, that driver 120 may be other types of transducer devices (e.g. a microphone).

Although not shown in FIG. 1, driver 120 and other processing circuitry within audio module 104 (e.g., contacts 114a-114d) may be electrically connected to a printed circuit board within device housing 102. The printed circuit board may support and electrically connect processing electronics that provide functions to portable electronic device 100. In addition, although a single driver 120 is illustrated, it is contemplated that more than one driver may be acoustically coupled to the tube 110 such that acoustic opening 108 may be used to output sound from multiple drivers.

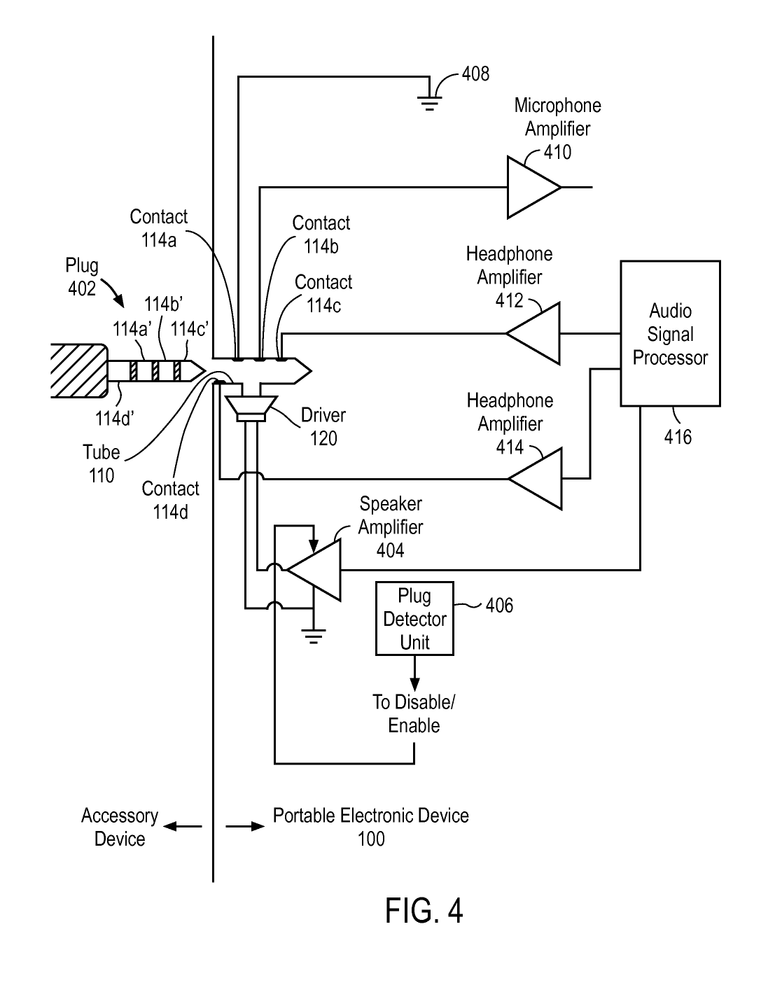

During operation of portable electronic device 100, audio module 104 provides an audio jack functionality when an audio plug of an auxiliary device is inserted into tube 110 and a speaker output functionality when the audio plug is not inserted into tube 110 as will be described in more detail in reference to FIG. 4. In this aspect, audio module 104 provides an audio jack which can also be used to output sound to a user through a single opening within device housing 102, namely acoustic opening 108. Since the same opening can be used as the audio jack and for sound output, the number of acoustic openings formed in device housing 102 can be reduced. For example, in some embodiments, acoustic opening 108 is the only acoustic opening formed in a side of device housing 102 and any additional speaker ports are omitted. In other embodiments, acoustic opening 108 is an additional acoustic opening formed in the side of the device housing 102.

In addition, although not illustrated, it is contemplated that in some embodiments, an acoustic damping material may be positioned within, for example, driver housing 116 or acoustic duct 122 to improve sound transmission and output from driver 120. Alternatively, acoustic damping may be achieved by a size, shape and/or material of the driver housing 116 or the acoustic duct 122 such that a separate damping material is not necessary.

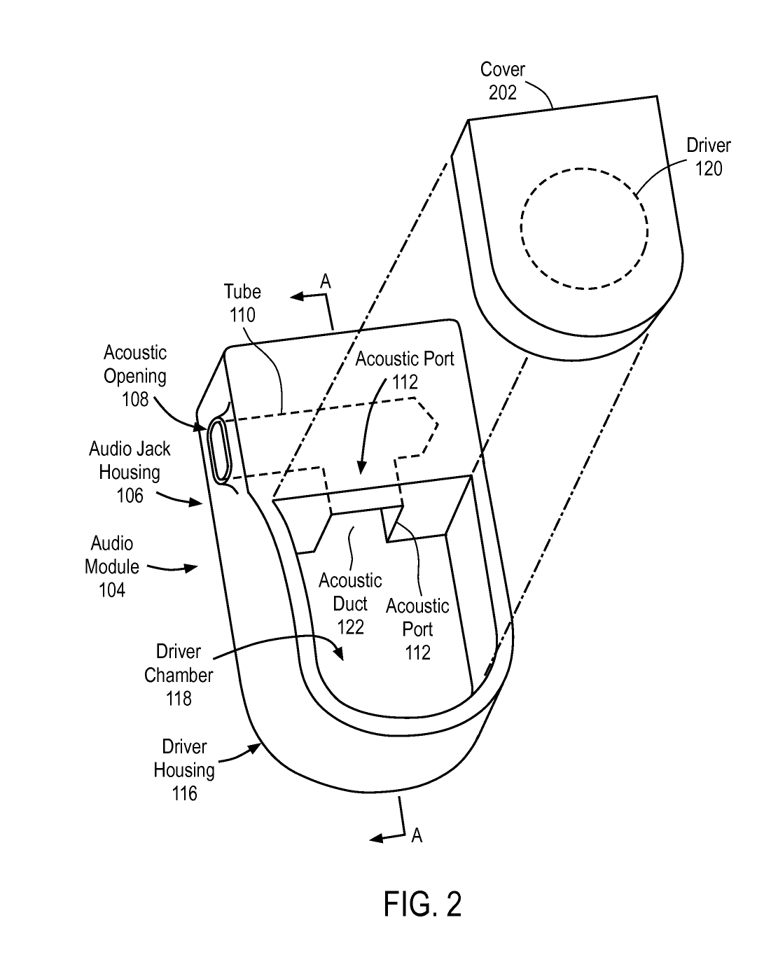

FIG. 2 is a perspective view of the combined audio jack and speaker module of FIG. 1. From this view, it can be seen that the audio jack housing 106 and driver housing 116 of audio module 104 can be made as one integrally formed structure which is a single unit, aside from cover 202. For example, in one embodiment, audio module 104 may be formed by injection molding a plastic substrate to form a first cavity (e.g., tube 110) for receiving the audio plug, a second cavity (e.g., driver chamber 118) for receiving driver 120 and acoustic duct 122 connecting the two together. The driver chamber 118 may be formed to include an open top or bottom side so that driver 120 can be mounted therein after audio module 104 is formed. For example, driver 120 may be mounted to a cover 202 dimensioned to close the open top or bottom side. Thus, to mount driver 120 within driver chamber 118, cover 202 is positioned over the open top or bottom side so that driver 120 is within driver chamber 118 and then cover 202 is sealed to driver housing 116. Alternatively, driver 120 may be separate from cover 202 such that driver 120 is mounted within driver chamber 118 prior to positioning cover 202 over the opening. Although not illustrated, openings for receiving contacts 114a-114d may also be formed within tube 110.

FIG. 3 is a side cross sectional view of the combined audio jack and speaker module of FIG. 2 along line A-A′. From this view, various aspects of audio module 104, as well as the direction of sound transmission through audio module 104, can be more clearly seen. In particular, it can be seen that audio jack housing 106 and driver housing 116 of audio module 104 are formed as one unitary structure. When cover 202 is placed over, in this case, the top opening 304 of driver housing 116, driver 120 is positioned within driver chamber 118. Driver 120 is positioned such that face 302 of driver 120, which outputs sound S, faces the bottom side of driver housing 116. The output sound S, is therefore output in a direction parallel to a z-axis, toward the bottom side of driver housing 116. Sound S can then be redirected by a combination of driver housing 116, acoustic duct 122 and tube 110 out the associated acoustic opening (e.g., acoustic opening 108) to the ambient environment. It is noted that although driver 120 is shown with the sound emitting face 302 emitting sound S in a downward direction (as viewed in FIG. 3), it may be reversed such that sound S is emitted in an upward direction. For example, the opening 304 of driver housing 116 may be formed in the bottom side of driver housing 116, instead of along the top side of driver housing 116. In this aspect, when cover 202 is placed over the opening in the bottom side of driver housing 116, face 302 of driver 120 faces a top of the driver housing 116 and emits sound in an upward direction.

It is further contemplated, that in some embodiments, the dimensions of the driver chamber 118 may be specially selected to improve an acoustic output of driver 120. For example, a size of driver chamber 118 may be increased or decreased to modify sound attenuation within driver housing 116 and/or a bass response of driver 120.

FIG. 4 is a circuit diagram of an embodiment the invention. In this embodiment, each of contacts 114a, 114b, 114c and 114d are shown electrically connected to ground 408, microphone amplifier 410, headphone amplifier 412 and headphone amplifier 414, respectively. Each of contacts 114a-114d are shown integrated within tube 110, which forms an audio jack socket within portable electronic device 100 as previously discussed in reference to FIG. 1. An audio plug 402 is further shown. Audio plug 402 may be, for example, a headset plug (e.g., a 3.5 mm TRRS connector) or any other electrical plug associated with any other type of device desired to be connected to the portable electronic device 100. For example, suitable devices may be auxiliary devices including, but not limited to, a microphone-speaker combination headset unit, an auxiliary speaker, an auxiliary microphone, or the like. In addition, audio plug 402 may be associated with an audio adapter capable of outputting audio to a vehicle entertainment system or other entertainment system.

Audio plug 402 may include reference contacts 114a′, 114b′, 114c′ and 114d′. Reference contacts 114a′, 114b′, 114c′ and 114d′ mate directly with contacts 114a, 114b, 114c and 114d of the portable electronic device 100, respectively, when audio plug 402 is inserted into tube 110. Mating of reference contacts 114a′-114d′ with contacts 114a-114d allows for audio signal processing and audio output by audio signal processor 416, which is electrically connected to each of headphone amplifier 412 and headphone amplifier 414. When audio plug 402 is removed from tube 110, however, audio processing of signals from audio plug 402 is disabled and tube 110 provides an open pathway for sound transmission from driver 120.

Driver 120 (e.g., a speaker) may be acoustically connected to tube 110 and electrically connected to ground, a speaker amplifier 404 as well as audio signal processor 416 for processing of speaker audio signals. In this aspect, when audio plug 402 is removed from tube 110, sound output by driver 120 may pass through tube 110 to the ambient environment. The presence or absence of audio plug 402 within tube 110 may be detected by plug detector unit 406. Plug detector unit 406 may be electrically connected to the processing circuitry within portable electronic device 100 such that it can detect when audio plug 402 is inserted within tube 110, such as by detecting a connection between contacts 114a-114d and reference contacts 114a′-114d′. Plug detector unit 406 may also detect when audio plug 402 is not within tube 110, such as by detecting a disconnection between contacts 114a-114d and reference contacts 114a′-114d′. When it is determined that audio plug 402 is within tube 110, speaker amplifier 404 may be disabled such that operation of driver 120 is disabled. When it is determined that audio plug 402 is not within tube 110, speaker amplifier 404 may be enabled such that operation of driver 120 is enabled. When driver 120 is enabled, audio may be processed and output by audio signal processor 416 to speaker amplifier 406 so that sound can be output by driver 120 (e.g., a speaker) through tube 110 to the ambient environment. For example, the audio signal processor 416 may process music audio files, audio signals from a far end user, or any other audio data desired to be output by driver 120 to the user. It is further to be understood, that other and/or additional circuitry configurations may be used to allow for both audio output by driver 120 and audio input by audio plug 402 using a single tube 110 (e.g., an audio jack socket).

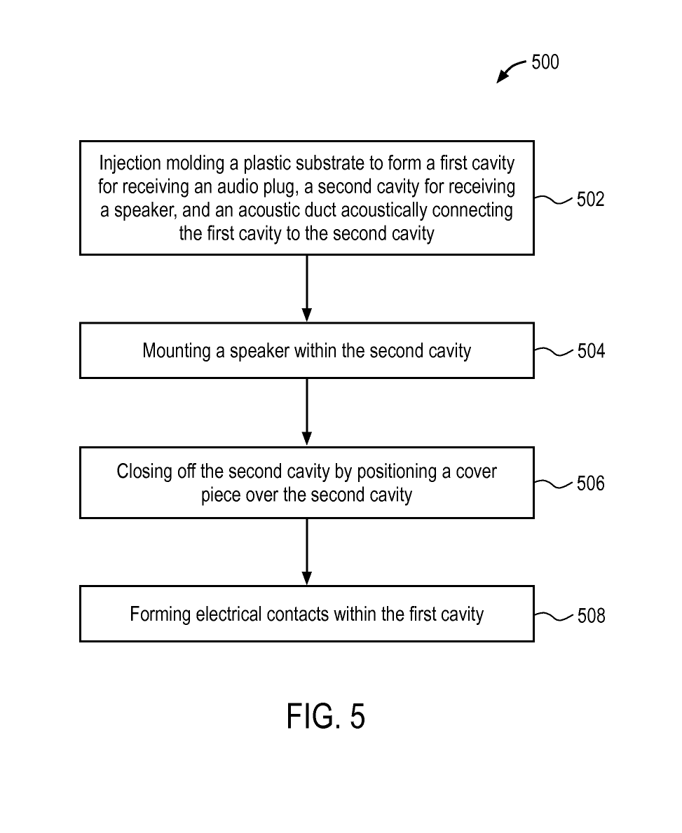

FIG. 5 is a flow diagram of an embodiment of a method of manufacturing a combined audio jack and speaker module. As previously discussed, in one embodiment, the combined audio jack and speaker module, also referred to herein as the audio module, is a single unitary structure having an audio jack housing dimensioned to receive an audio plug and a driver housing dimensioned to receive a driver. In one embodiment, the audio module may be formed according to an injection molding process as illustrated by flow diagram 500. Representatively, a plastic substrate may be injection molded such that it includes a first cavity for receiving an audio plug, a second cavity for receiving a speaker and an acoustic duct acoustically connecting the first cavity to the second cavity (block 502). Although a plastic substrate is described as the starting material, it is contemplated that other non-conductive starting materials may also be used (e.g., silicone or rubber). Once the plastic housing having each of the above described cavities is formed, a speaker may be mounted within the second cavity (block 504). In one embodiment, the speaker may be mounted within the second cavity by inserting it through an opening formed in a top or bottom side of the second cavity. It is noted that although a top or bottom side opening is disclosed, the opening could be in any portion of the second cavity sufficient to allow for insertion of a driver there through. Once the driver is positioned within the second cavity, the second cavity is closed off by positioning a cover piece over the opening (block 506). Electrical contacts may further be formed within the first cavity to allow for electrical connections to be made with an audio plug inserted within the first cavity (block 508).

It is noted that FIG. 5 illustrates only one exemplary process for forming an audio module using an injection molding technique. It is contemplated that other manufacturing steps and/or processes may be used to form an integrated audio module. For example, molding processes other than injection molding, such as compression molding, may be suitable. In addition, the first cavity, which is part of the audio jack housing portion (e.g., audio jack housing 106), and second cavity, which is part of the driver housing portion (e.g., driver housing 116), may be formed together from a single substrate, or separately formed and then integrally connected together to form the audio module.

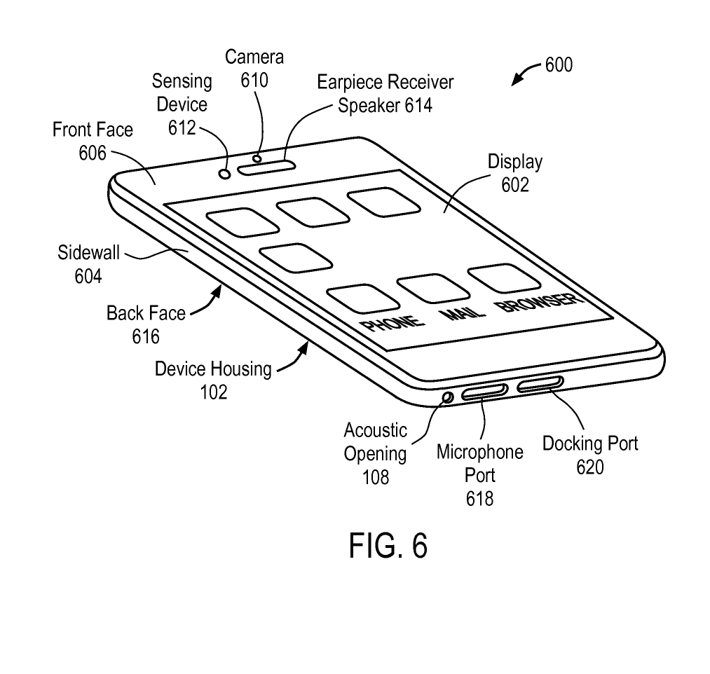

Turning now to FIG. 6, FIG. 6 shows one exemplary portable electronic device within which the audio module may be implemented. Representatively, in this embodiment, the portable electronic device is a portable handheld electronic communications device 600 (also referred to as a mobile device or a wireless device), such as an iPhone® device by Apple Inc. of Cupertino, Calif. Portable device 600 may include an outer case or housing 102 that includes at least a front face 606 and a mating back face 616, that when fitted to each other in large part define or close off a chamber in which the constituent electronic components of the portable device 600 are housed. The front and back faces 606, 616 may be connected together by a sidewall 604, that extends around the entire device.

The front face 606 may form part of a display 602 (e.g., a touch screen display) as well as a port for accommodating an earpiece receiver speaker 614. In addition, a sensing device 612 (e.g., proximity sensor) and a camera 610 may be positioned along the front face 606.

Various other ports and/or openings may also be formed along sidewall 604. For example, a docking port 620 for plugging device 600 into a peripheral device or power source and a microphone port 618 may be formed along a portion of sidewall 604 forming the end of portable device 600.

In addition to these ports, an acoustic opening 108 may be formed within the sidewall. The acoustic opening 108 may be associated with the previously discussed audio module such that it can be used as both an audio jack for an audio plug as well as a sound output port for outputting sound from a speaker mounted within portable device 600. Since acoustic opening 108 provides both functionalities, an additional speaker port, as is the case in typical communications devices, is not needed and the number of ports along the sidewall 604 is reduced. It is noted that although acoustic opening 108 is shown along a portion of sidewall 604 forming an end of portable device 600, acoustic opening 108 may be formed along any portion of sidewall 604 (e.g., a portion forming the top or side of portable device 600). Alternatively, acoustic opening 108 may be formed along face 606 or 616 of device housing 102.

It is to be understood that although a handheld device such as an iPhone® from Apple Computer, Inc. of Cupertino, Calif., is illustrated in FIG. 6, the audio module disclosed herein may be implemented within any number of electronic devices that could benefit from fewer audio ports. For example, the audio module may be implemented within a tablet computer, a notebook computer or other portable computing device. In still further embodiments, the audio module may be implemented within a digital media player, such as a portable music and/or video media player, entertainment systems or personal digital assistants (PDAs), or general purpose computer systems, or special purpose computer systems, or an embedded device within another device, or cellular telephones which do not include media players, or devices which combine aspects or functions of these devices (e.g., a media player, such as an iPod®, combined with a PDA, an entertainment system, and a cellular telephone in one portable device).

Also, although not described here, the device 600 has within its outer housing the needed combination of electronic circuitry and stored software that operate the various input and output components (e.g., touch sensitive display, receiver, microphone, and antenna), to provide the user with mobile telephony functionality.

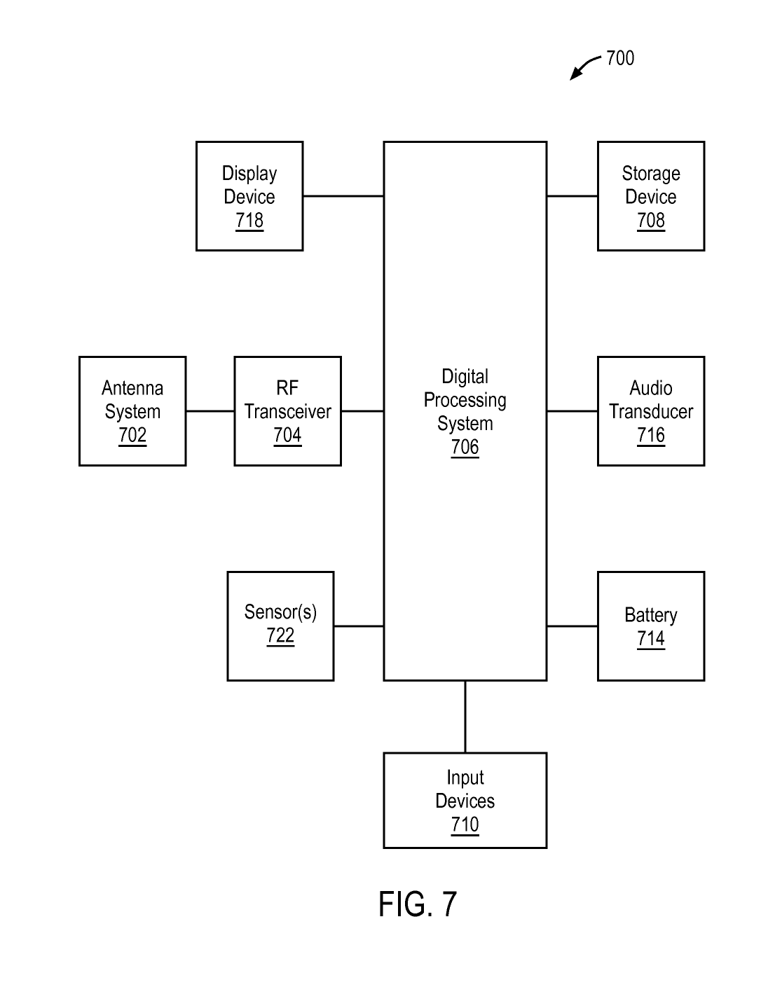

Referring now to FIG. 7, FIG. 7 shows a block diagram of an embodiment of a wireless device 700 within which the previously described audio module may be implemented. In the illustrated embodiment, wireless device 700 is a wireless communication device. The wireless device 700 may be included in the device shown in FIG. 6, although alternative embodiments of portable device 600 may include more or fewer components than the wireless device 700.

Wireless device 700 may include an antenna system 702. Wireless device 700 may also include a radio frequency (RF) transceiver 704, coupled to the antenna system 702, to transmit and/or receive voice, digital data and/or media signals through antenna system 702.

A digital processing system 706 may further be provided to control the digital RF transceiver and to manage the voice, digital data and/or media signals. Digital processing system 706 may be a general purpose processing device, such as a microprocessor or controller for example. Digital processing system 706 may also be a special purpose processing device, such as an ASIC (application specific integrated circuit), FPGA (field-programmable gate array) or DSP (digital signal processor). Digital processing system 706 may also include other devices to interface with other components of wireless device 700. For example, digital processing system 706 may include analog-to-digital and digital-to-analog converters to interface with other components of wireless device 700.

A storage device 708, coupled to the digital processing system, may further be included in wireless device 700. Storage device 708 may store data and/or operating programs for the wireless device 700. Storage device 708 may be, for example, any type of solid-state or magnetic memory device.

One or more input devices 710, coupled to the digital processing system 706, to accept user inputs (e.g., telephone numbers, names, addresses, media selections, etc.) or output information to a far end user may further be provided. Exemplary input devices may be, for example, one or more of a keypad, a touchpad, a touch screen, a pointing device in combination with a display device or similar input device.

Display device 718 may be coupled to the digital processing system 706, to display information such as messages, telephone call information, contact information, pictures, movies and/or titles or other indicators of media being selected via the input device 710. Display device 718 may be, for example, an LCD display device. In one embodiment, display device 718 and input device 710 may be integrated together in the same device (e.g., a touch screen LCD such as a multi-touch input panel which is integrated with a display device, such as an LCD display device). It will be appreciated that the wireless device 700 may include multiple displays.

Battery 714 may further be provided to supply operating power to components of the system including digital RF transceiver 704, digital processing system 706, storage device 708, input device 710, audio transducer 716, sensor(s) 722 (e.g., a proximity sensor), and display device 718. Battery 714 may be, for example, a rechargeable or non-rechargeable lithium or nickel metal hydride battery. Wireless device 700 may also include audio transducers 716, which may include one or more speakers, receivers and at least one microphone.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. For example, although a speaker type drive is generally disclosed herein, it is contemplated that in some embodiments, the driver may be a microphone such that the audio jack housing, and in particular the tube portion provides a pathway for sound input to the microphone as well as an audio jack functionality. In still further embodiments, both a speaker and a microphone may be acoustically coupled to the audio jack housing such that sound input to the microphone and/or sound output from the speaker may be accommodated by the audio jack housing when the audio plug is removed. In addition, although the host device for the audio module is described herein as a portable electronic device (e.g., a smart phone device or a media player device), it is further contemplated that the audio module may be integrated within any type of device which typically includes separate audio jack and speaker ports. For example, the audio module may be integrated within a stationary electronic device such as a desktop computer, a television set, a desk top telephone, an automobile audio system or the like. The description is thus to be regarded as illustrative instead of limiting.

1. A speaker and audio jack module for a portable electronic device, the module comprising:
an audio jack housing defining a tube dimensioned to receive an audio plug;
an acoustic port formed through a sidewall of the tube, the sidewall forming an inside inner radius of the tube; and
a speaker housing acoustically coupled to the acoustic port, the speaker housing dimensioned to contain a speaker therein, and
wherein the audio jack housing is capable of outputting sound from the speaker when the audio plug is absent.

2. The module of claim 1 wherein an acoustic duct acoustically couples the speaker to the acoustic port.

3. The module of claim 1 wherein the speaker is indirectly coupled to the tube.

4. The module of claim 1 wherein the speaker housing defines a chamber around the speaker, the chamber including a top surface and a bottom surface positioned along opposing faces of the speaker.

5. The module of claim 1 wherein the speaker is connected to a top surface of the speaker housing and emits sound waves toward a bottom surface of the speaker housing.

6. The module of claim 1 wherein the audio jack housing and the speaker housing are a single molded piece.

7. The module of claim 1 further comprising:
an acoustic mesh positioned over the acoustic port.

8. The module of claim 1 further comprising:
a plurality of electrical contacts formed within the tube so as to make electrical contact with the audio plug when inserted within the tube.

9. The module of claim 8 wherein the speaker is disabled when electrical contact is made with the audio plug and the speaker is enabled when electrical contact is not made with the audio plug.

10. The module of claim 1 wherein the portable electronic device is a mobile communications device.

11. A portable electronic device comprising:
a portable electronic device housing having an acoustic opening formed through a sidewall thereof;
an electrical socket extending from the acoustic opening and within the portable electronic device housing, the electrical socket having an open end and a closed end connected by a sidewall, wherein the open end is dimensioned to receive an audio plug; and
a driver housing acoustically coupled to the electrical socket by an acoustic duct extending from the sidewall of the electrical socket, and
wherein the electrical socket is capable of receiving an audio input when the audio plug is inserted therein and outputting an audio output from the driver when the audio plug is removed.

12. The portable electronic device of claim 11 wherein the driver is a speaker.

13. The portable electronic device of claim 11 wherein the audio output is a sound generated by the driver.

14. The portable electronic device of claim 11 wherein the acoustic opening is the only acoustic opening formed in the sidewall.

15. The portable electronic device of claim 11 wherein the electrical socket and the driver housing form one integrally molded single piece.

16. The portable electronic device of claim 11 further comprising:
processing circuitry contained within the housing, wherein the processing circuitry is electrically connected to the electrical socket.

17. The portable electronic device of claim 16 wherein the processing circuitry allows for activation of the driver when the audio plug is removed from the electrical socket and inactivation of the driver when the audio plug is inserted.

18. A method of manufacturing a speaker and audio jack module for a portable electronic device comprising:
injection molding a plastic substrate to form (a) a first cavity having a first end, a second end and a sidewall connecting the first end to the second end, the first end dimensioned for receiving an audio plug, and the sidewall having an acoustic port, (b) a second cavity for receiving a speaker, and (c) an acoustic duct extending from the acoustic port of the first cavity to the second cavity to acoustically connect the first cavity to the second cavity; and
mounting a speaker within the second cavity.

19. The method of claim 18 wherein the speaker is connected to a cover piece positioned over the second cavity to close off the second cavity.

20. The method of claim 18 further comprising:
forming electrical contacts within the first cavity.
